(19) United States
(12) Patent Application Publication
(10) Pub. No.: US 2005/0159259 A1
(43) Pub. Date: Jul. 21, 2005

(54) Hydraulic pressure control method for variator pulleys of a continuously variable transmission

(76) Inventors: Holger Bacher, Lindau (DE); Lothar Beller, Langenesnlingen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/992,994

(22) Filed: Nov. 19, 2004

(30) Foreign Application Priority Data
Nov. 22, 2003 (DE) 103 54 705.3

(51) Int. Cl. F16H 59/00; F16H 63/00

(52) U.S. Cl. 474/12; 474/11; 474/17; 474/28

(57) ABSTRACT

A method for adjusting an optimal contact pressure on the pulleys of a variator of a continuously variable transmission, to adjust an optimal contact pressure, the road condition is detected and based on the road condition, the contact pressure is adjusted so that in case of poor road condition the pressure level is raised thereby obtaining a mode of operation free of interference and an improved protection of the variator.

According to the preamble of claim 1, this invention relates to a method for adjustment of an optimal contact pressure on the pulleys of a variator of a continuously variable transmission.

A continuously variable chain drive transmission customarily consists of one starting unit, one forward/reverse drive unit, one intermediate shaft, one differential, hydraulic and electronic devices, the same as of one variator.

In the prior art, the variator comprised one primary and one secondary pulley, also called primary and secondary side, both pulleys being formed by cone pulleys disposed in pairs. In addition, a variator is provided with a torque-transmitting encircling element which rotates between the two pairs of cone pulleys.

In a transmission of that kind, the actual ratio is defined by the tread radius of the encircling element which, in turn, is a function of the axial position of the cone pulleys.

To save fuel, it is important to keep the basic contact pressure of the encircling element on the pulleys as low as possible. When the contact pressure is low, the transmission is no longer well protected against torque impacts of the driven shaft. Those torque impacts can be produced, for example, by road irregularities like pot-holes or transverse furrows, the same as spinning or blocking wheels.

The problem on which this invention is based is to outline a method which ensures the adjustment of an optimal contact pressure on the pulleys of a variator so as to obtain the best possible fuel economy on one hand and a mode of operation free of interferences and independent of torque impacts form the driven shaft on the other.

This problem is solved by the features of claim 1. Other developments and advantages result from the sub-claims.

It is accordingly proposed for an adjustment of an optimal contact pressure on the pulleys of a variator to detect the condition of the road and to adjust the contact pressure on the basis of the detected condition of the road.

The inventive idea makes it possible to classify the road lining so that in roads where critical incidents often occur, due to the condition of the road, the pressure level is somewhat raised thus obtaining an uninterrupted mode of operation and a better protection of the variator.

To detect the condition of the road according to the invention, it is proposed to observe the wheel rotational speeds which are, in any case, available via the CAN. The wheel speeds available on the CAN are observed here for each wheel. In addition, the measured wheel speeds are weighted, averaged and subtracted from the measured value. Thereby a signal is obtained which expresses the divergence of the wheel speed from an idealized wheel speed.

This signal is averaged by forming a mean value via a preset number of values, preferably five, in order to make the critical incidents more clear. The obtained signal has a very high noise level from which a clear peak results during each high-frequency change of the wheel speed. These peaks can be detected via a speed-dependent threshold and are later evaluated. The detected peaks show incidents on the wheels which, in most cases, originate from road irregularities.

The detected incidents are counted for evaluation. This can be done both for each wheel individually and also via linkage of the wheels. The linkage used here can be one AND- or OR-linkage. If this meter reaches an applicable threshold, a defective way is detected. If no incident is detected for an applicable time, the meter is again returned to zero and an eventually detected defective way is canceled.

By the method introduced here, it is possible to detect changes produced on the wheel speeds by interference from outside withe relatively simple means. Contrary to the current method of signal analysis, a small signal scanning rate is sufficient. By said circumstance, the evaluation of a vehicle CAN signal is possible for the first time. The detection of these changes is to a great extent independent of torque changes in the drive train. According to the invention, erroneous detections are extensively ruled out by adequately long filtering times during which incidents must occur.

Within the scope of a specially advantageous alternative of the invention, it is further proposed to classify the detected incidents so as to implement, for example, the detection of a spinning wheel during cornering or during the acceleration phase. Besides, the one-sided crossing of a bad subsurface can be detected.

The invention is illustratively explained in detail herebelow with reference to the enclosed figures which show:

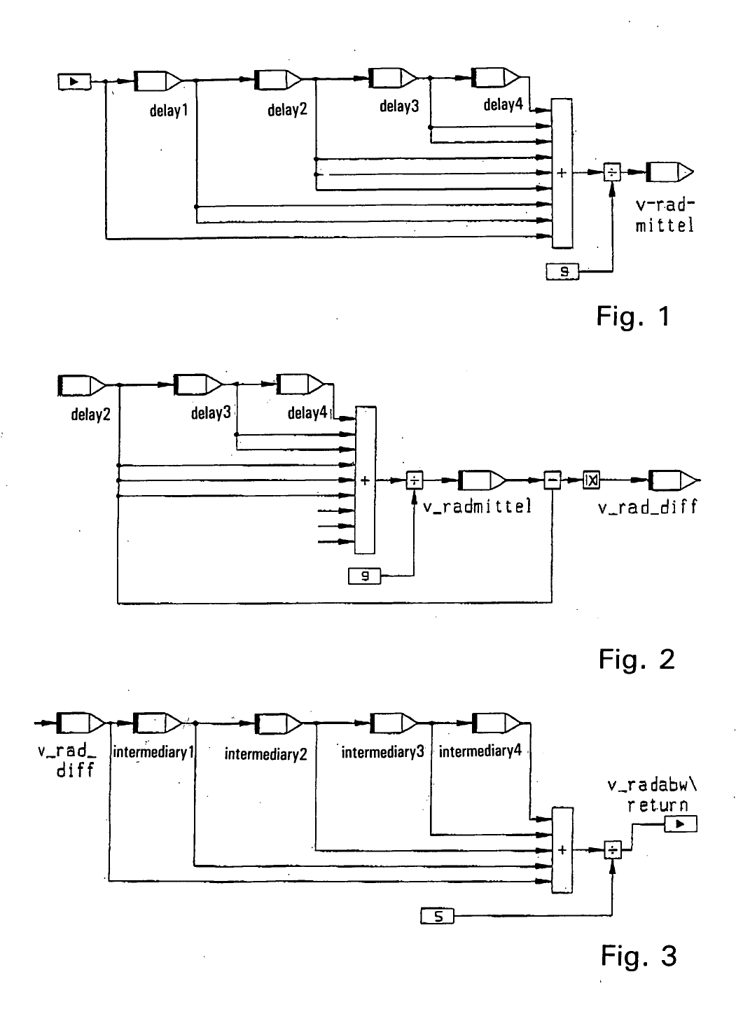

FIG. 1 is a diagrammatic graph of the weighted mean value formation of the wheel speeds;

FIG. 2 is a diagrammatic graph of the calculation of the difference between measured and averaged wheel speed;

FIG. 3 is a diagrammatic graph of the calculation of the gradient of the summed up difference over five steps;

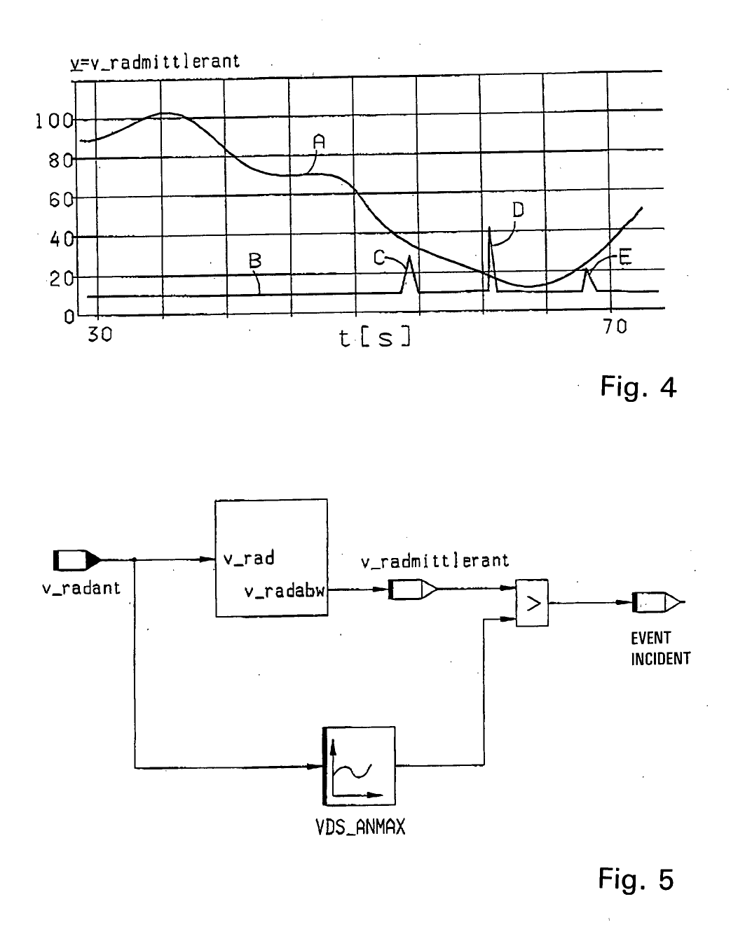

FIG. 4 is one example of the detection of the road condition according to the instant invention; and

FIG. 5 is a diagrammatic graph of the detection of an incident via a speed-dependent threshold.

FIG. 1 illustrates the formation of the weighted mean value of the wheel signals inventively carried out over five steps. In this case, the weighting is 1-2-3-2-1; the averaged signal has a delay of 20 ms.

According to the invention, this delay is compensated since then the averaged signal is compared with the one delayed by 20 ms. A delay of 20 ms thus results which for the required function is more than sufficient. The number of arrows in each step (calc/in, delay 1, delay 2, delay 3, delay 4) corresponds here to the weighting; for example, from the third step delay 2, three arrows enter in the formation of the sum. In this case, the average results by dividing the sum by the number of the weights, namely, nine, in order thus to obtain the weighted mean value of the wheel speeds v_radmittel.

The averaged signal v_radmittel is subtracted from the wheel signal that has been measured and delayed by two task steps, the amount being formed from the difference, thereby obtaining the divergence of the wheel rotational speeds v_rad_diff from the idealized curve. This step is illustrated in FIG. 2.

As shown in FIG. 3, the divergences are added up via five steps and divided by five (that is, averaged) so that as a result, the mean gradient of the divergence v_radabw is obtained via said five steps. The mean gradient of the divergence v_radabw is the criterion for the detection of abnormal incidents on the wheels. FIG. 4 shows the mean gradient of the divergence (curve A) and the averaged wheel speed (curve B). Here can be recognized two passages of a gutter (peaks C and D) and a spinning of the drive wheels during the acceleration phase (peak E).

The mean gradient of the divergence is speed dependent; for this reason, the detection threshold is stored in a characteristic line over the wheel speed. If the characteristic line value is exceeded then an incident is detected on the wheel. This is made clear with reference to FIG. 5 where the medium wheel speed is compared with the characteristic line VDS_ANMAX which shows the detection threshold as a function of the wheel speed v_rad.

According to the invention, one evaluation is separately carried out for each wheel. Upon each incident detected, the incident meter value incrementally increases and the exit time set in a timer. If the exit time is reached, since for long period no incident has been detected, the incident meter value is incrementally decreased. The incident meter is limited to a maximum value which is also the detection threshold for defective way. When the incident meter reaches the value zero, “defective way” is again removed. The size of the incremental increase, the incremental decrease and the maximum value are applicable parameters according to the invention.

Within the scope of another alternative of the inventive method, it is provided that the incidents in each wheel be summed up by one OR linkage so that for all wheels an incident meters value incrementally increases and the exit time set in a timer. If the exit time is reached since for long no incident has been detected any more, the incident meter value incrementally decreases. The incident meter is limited to a maximum value which is also the detection threshold for defective way. The size of the incremental increase, the incremental decrease and the maximum value, are also in this case applicable parameters.

The inventive detection of road irregularities by means of the gradient of the summed up difference between the measured wheel speed and the weighted mean value of the wheel speed makes a simple and reliable method available which makes the adaptation of the contact pressure to the condition of the road possible.

1-10. (canceled)

11. A method for adjusting an optimal contact pressure on pulleys of a variator of a continuously variable transmission, the method comprising the steps of:
adjusting an optimal contact pressure,
detecting a road condition, and
on a basis of the detected road condition, adjusting the contact pressure such that in case of a poor road condition, a pressure level is raised, thereby obtaining a mode of operation free of interference and improved protection of the variator.

12. The method according to claim 11, further comprising the step of detecting the road condition with reference to an evaluation of wheel rotational speeds.

13. The method according to claim 11, further comprising the step of detecting road irregularities by a gradient of a summed up difference between a measured wheel speed and a weighted mean value of the wheel speed.

14. The method according to claim 11, wherein for each wheel a measured speed is weighted, averaged and subtracted from a measuring value, thereby obtaining a signal which expresses a divergence of the wheel speed from an idealized wheel speed and a signal is averaged by forming a means value via a preset number of values, peaks in the signal showing incidents on the wheels originating from road irregularities.

15. The method according to claim 14, further comprising the step of providing a detection threshold, dependent on the wheel speed, and when the threshold is exceeded, peaks are detected as road irregularities.

16. The method according to claim 15, further comprising the step of storing the detection threshold in a characteristic line over the wheel speed.

17. The method according to claim 11, wherein when each incident is detected, an incident meter value is incrementally increased and an exit time is set in a timer wherein, when the exit time is reached, since for a long period no incident has been detected, the incident meter value is incrementally decreased, the incident meter being limited to a maximum value which forms a detection threshold for defective way and when the incident meter reaches the zero value, “defective way” is removed.

18. The method according to claim 17, wherein the step size for the incremental increase, the incremental decrease and the maximum value are applicable parameters.

19. The method according to claim 17, further comprising the step of summing up the incidents of each wheel by an “AND” or an “OR” linkage.

20. The method according to claim 14, wherein a weighted mean value formation of wheel signals is carried out via five steps, there being selected as weighting 1-2-3-2-1, and that a delay in the averaged signal is compensated by comparing the averaged signal with a corresponding delayed measuring signal.

21. A method for adjusting an optimal contact pressure on pulleys of a variator of a continuously variable transmission comprising the steps of:
detecting a road condition;
adjusting the contact pressure on a basis of the detected road condition;
raising the contact pressure level when a poor road condition is thereby obtaining a mode of operation free of interference and better protection of the variator.
